(19) United States
(12) Patent Application Publication
(10) Pub. No.: US 2005/0061132 A1
(43) Pub. Date: Mar. 24, 2005

(54) Cutter unit, half-cutting mechanism, and tape printer

(75) Inventor: Hideo Sodeyama, Nagano-ken (JP)

Correspondence Address: HOGAN & HARTSON L.L.P., 500 S. GRAND AVENUE, SUITE 1900, LOS ANGELES, CA, 90071-2611, US

(73) Assignees: SEIKO EPSON CORPORATION; KING JIM CO., LTD.

(21) Appl. No.: 10/917,842

(22) Filed: Aug. 13, 2004

(30) Foreign Application Priority Data
Aug. 19, 2003 (JP) 2003-295348
Aug. 19, 2003 (JP) 2003-295349

(51) Int. Cl. B26D 1/00

(52) U.S. Cl. 83/694

(57) ABSTRACT

A cutter unit includes a cutter frame, a scissors-type of full cutter having a fixed blade fixed to the cutter frame and a movable blade pivotally supported on the fixed blade, and a force-cutting half cutter having a straight-tooth cutting blade and a blade-receiving member for receiving the cutting blade when the cutting blade is operated. The full cutter and the half cutter are disposed close to each other so as to face a feeding path for a tape medium to be cut, and the blade-receiving member is fixed to the fixed blade.

### BACKGROUND OF THE INVENTION

1. Field of the Invention

This invention relates to a cutter unit having a half cutter for half-cutting a printing tape and a full cutter for fully cutting the printing tape, a mechanism of the half cutter (half-cutting mechanism), and a tape printer having the cutter unit/half-cutting mechanism.

2. Description of the Related Art

A tape printer is known which includes a half-cutting mechanism for cutting only one of a printing tape and a release tape (release paper layer) of a laminate tape (tape medium), and a full-cutting mechanism for cutting both the printing tape and the release tape. The half-cutting mechanism includes a receiver fixed, e.g., to a frame (cassette compartment) inside a case, a support member turnably supported on a base of the receiver, a cutting blade fixed to the support member, and a driving means for turning the support member. A laminate tape placed between the cutting blade and the receiver is half-cut in a so-called force-cutting manner by turning the support member relative to the receiver by the driving means.

A tape-printer cutting apparatus having such a half-cutting mechanism includes a cutter blade, a cutter-supporting member for supporting the cutter blade, and a receiver opposing the cutter-supporting member to receive the cutter blade. The cutter-supporting member has a pair of protruding portions that protrude from the cutter blade by an amount corresponding to the thickness of a release paper layer of a laminate tape. In this cutting apparatus, the gap between the cutter blade and the receiver is regulated by the contact of the protruding portions with the receiver during a half-cutting operation, thereby cutting only a printing tape of the laminate tape.

When a laminate tape is half-cut in a force-cutting manner, since the cutting blade is pressed hard against the receiver with the laminate tape disposed therebetween, the receiver receives a strong pressing force (moment), and a large bending moment is also applied to the frame that supports the receiver and the cutting blade. Therefore, the frame is required to have a sufficient strength to withstand the bending moment applied by half-cutting. Conventionally, the strength of the frame is increased by forming the frame itself of a sufficiently thick plate or by using a reinforcing member for the frame. However, when the frame is thickened, as in the former case, the manufacturing cost of the frame is increased, and the weight of the cutting apparatus is increased. In the latter case, since the number of components is increased, the manufacturing cost is increased, and management of the components is complicated during the manufacturing process of the apparatus.

In the above cutting apparatus, the edge of the cutter blade is indirectly positioned on the receiver through the cutter-supporting member. Therefore, it must be precisely positioned in order to precisely control the gap between the cutting blade and the receiver. This decreases the assembly efficiency of the cutting apparatus.

### SUMMARY OF THE INVENTION

Accordingly, it is an advantage of this invention to provide a cutter unit having a simple, but strong frame structure that can withstand a force applied during a half-cutting operation.

It is another advantage of this invention to provide: a half-cutting mechanism in which the gap between a cutting blade and a receiver can be precisely controlled and in which the cutting blade can be easily and precisely positioned and mounted to a cutter-supporting member; and a tape printer.

In order to attain the above advantage, according to an aspect, this invention provides a cutter unit comprising a cutter frame, a scissors-type of full cutter (i.e., a full cutter having a shape like a pair of scissors) including a fixed blade fixed to the cutter frame and a movable blade pivotally supported on the fixed blade, and a force-cutting half cutter including a straight-tooth cutting blade and a blade-receiving member for receiving the cutting blade when the cutting blade is operated. The full cutter and the half cutter are disposed close to each other so as to face a feeding path for a tape medium to be cut, and the blade-receiving member is fixed to the fixed blade.

According to this arrangement, since the blade-receiving member for receiving the cutting blade is fixed to the fixed blade, a pressing force that the blade-receiving member receives from the cutting blade during the half-cutting operation can be distributed and applied to the fixed blade and the cutter frame. Moreover, since the full cutter and the half cutter face the feeding path, the fixed blade and the blade-receiving member protrude from the cutter frame. By fixing the fixed blade and the blade-receiving member thus protruding to each other, the strengths thereof can be increased while maintaining the functions.

Preferably, the cutter frame includes a blade-receiving-member support portion for fixing the blade-receiving member, and a fixed-blade support portion for fixing the fixed blade. The blade-receiving member is fixed to the blade-receiving-member support portion, and the fixed blade is fixed to the fixed-blade support portion and is also fixed to the blade-receiving-member support portion with the blade-receiving member disposed therebetween.

According to this arrangement, a force applied to the blade-receiving-member support portion can be distributed to the fixed blade and the fixed-blade support portion during a half-cutting operation. Therefore, it is possible to simplify the cutter frame while maintaining its strength in consideration of the force applied to the fixed blade and the fixed-blade support portion.

Preferably, a resin spacer is interposed between the fixed blade and the blade-receiving member.

According to this arrangement, the spacer absorbs a shock produced when the cutting blade abuts against the blade-receiving member, and prevents partial stress concentration on the blade-receiving member and the fixed blade during a half-cutting operation.

Preferably, the fixed blade has a base portion and an edge portion extending from the base portion, and is thereby substantially L-shaped. The base portion is fixed to the fixed-blade support portion, and the edge portion is fixed to the blade-receiving-member support portion.

According to this arrangement, since the fixed blade is substantially L-shaped and is fixed to the fixed-blade support portion and to the blade-receiving-member support portion, the force applied to the fixed-blade support portion and the blade-receiving-member support portion can be efficiently distributed to the fixed blade. Furthermore, the force applied to the blade-receiving-member support portion during the half-cutting operation can be distributed to the fixed blade and the fixed-blade support portion. Moreover, the strength of the fixed blade itself can be increased.

Preferably, the cutter unit further comprises full-cutter driving means for making the full cutter to perform a full-cutting operation and half-cutter driving means for making the half cutter to perform a half-cutting operation. The full-cutter driving means and the half-cutter driving means are disposed on both sides of the feeding path.

According to this arrangement, since the full-cutter driving means and the half-cutter driving means are disposed on both sides of the feeding path, the thickness of the cutter unit in the tape feeding direction can be reduced. Consequently, the tape-feeding path in the cutter unit can be shortened, and a tape medium can be properly discharged from the cutter unit.

Preferably, the cutter unit further comprises a tape-discharging means operated by the full-cutter driving means to forcibly discharge the tape medium after the full-cutting operation.

According to this arrangement, since the cutter unit has the tape-discharging means, the tape medium can be reliably discharged from the cutter unit after the full-cutting operation, and can thus be prevented from jamming and double cutting. In addition, since the tape-discharging means is operated by the full-cutter driving means, a separate power source for operating the tape-discharging means is unnecessary, and the structure can be simplified. Moreover, the tape medium can be discharged in synchronization with cutting with the full cutter.

According to another aspect, this invention provides a half-cutting mechanism comprising a cutting blade having a straight-tooth blade portion, and a blade-receiving member for receiving the cutting blade parallelly opposite to an edge line of the blade portion when the cutting blade is operated. One of a printing tape and a release paper layer that constitute a laminate tape medium is cut in a force-cutting manner by abutting the cutting blade against the blade-receiving member while the laminate tape medium is placed between the cutting blade and the blade-receiving member. The half-cutting mechanism further comprises a pair of regulating members for regulating a gap between an edge of the blade portion and an edge-receiving surface of the blade-receiving member. The regulating members include a blade-side regulating member provided on the cutting blade to protrude toward the blade-receiving member, and a receiving-side regulating member provided on the blade-receiving member to protrude toward the cutting blade. The regulating members are disposed outside the blade portion in the longitudinal direction of the blade portion.

According to this arrangement, when the cutting blade is operated, the blade-side regulating member provided on the cutting blade abuts against the edge-receiving surface, and the receiving-side regulating member provided on the blade-receiving member abuts against the cutting blade. Consequently, the gap between the edge of the blade portion and the edge-receiving surface is regulated. Therefore, the depth of cutting of the tape medium with the blade portion can be precisely controlled. For example, when the blade-side regulating member is provided at a leading end of the cutting blade and the receiving-side regulating member is provided at a base end of the blade-receiving member, the regulating members do not interfere with insertion of the tape medium from the leading end of the blade portion.

Preferably, the cutting blade includes a blade holder for holding the blade portion so that the edge line of the blade portion is parallel to a front end face of the blade holder in the cutting direction, and the blade-side regulating member is disposed on the front end face of the blade holder so as to abut against the edge-receiving surface.

According to this arrangement, since the blade-side regulating member abuts against the edge-receiving surface, the gap between the front end face of the blade holder in the cutting direction and the edge-receiving surface is thereby regulated. Therefore, the gap can be directly regulated by the blade holder, and can be maintained precisely.

Preferably, the blade holder has a recess for positioning the blade portion, and the blade portion is held in the recess so that the edge of the blade portion is flush with the front end face of the blade holder in the cutting direction.

According to this arrangement, the blade portion is held in the recess of the blade holder so that the edge is flush with the front end face of the blade holder in the cutting direction. Therefore, the edge of the blade portion can be easily and precisely positioned with respect to the front end face of the blade holder, and the blade portion can be easily and quickly held in the blade holder in a proper condition. Moreover, the blade portion can be prevented from being displaced relative to the blade holder by a force applied during half-cutting.

Preferably, the cutting blade has an arm member for supporting the center of the blade holder so that the blade holder turns.

According to this arrangement, since the blade holder turns along the edge-receiving surface when the cutting blade is operated, an error in mounting the blade holder to the arm member can be cancelled. Therefore, the tape medium can be precisely and uniformly cut in a force-cutting manner.

Preferably, the cutting blade performs a half-cutting operation by turning the blade on a pivot provided in a base portion of the blade-receiving member.

According to this arrangement, the cutting blade can perform half-cutting with a relatively simple structure like a pair of scissors by turning the blade on the pivot. That is, since the cutting blade is operated like a pair of scissors, a slide guide or the like for moving the cutting blade can be omitted. This simplifies the structure of the half-cutting mechanism.

Preferably, the blade-side regulating member is provided at a leading end of the cutting blade, and the receiving-side regulating member is provided in the base portion.

According to this arrangement, since the blade-side regulating member is provided at the leading end of the cutting blade, when the tape medium is put between the cutting blade and the blade-receiving member, the cutting blade can be turned away from the tape medium, and does not interfere with the tape medium. Moreover, when the blade portion is mounted on the blade holder with its leading end properly positioned, the blade-side regulating member does not interfere with the mounting.

Preferably, the half-cutting mechanism further comprises a half-cut motor for making the cutting blade to perform a half-cutting operation, a power transmission mechanism for transmitting power of the half-cut motor to the cutting blade, home-position detecting means for detecting the home position of the cutting blade, and control means for making the cutting blade to perform the half-cutting operation by driving the half-cut motor for a predetermined period of time with a timer control when the cutting blade reaches the home position.

According to this arrangement, the cutting blade can properly perform half-cutting by controlling the driving of the half-cut motor with a combination of timer control and detection with the home-position detecting means. That is, since the cutting blade can always start cutting at the home position, a tape medium can be reliably half-cut by driving the half-cut motor under timer control.

Preferably, the power transmission means includes a torque limiter that limits a force-cutting pressure applied from the cutting blade to the tape medium.

According to this arrangement, the power transmission means includes the torque limiter, half-cutting can be reliably performed. Moreover, the half-cut motor can be stably driven without being overloaded.

According to a further aspect, this invention provides a tape printer comprising the above-described cutter unit or the above-described half-cutting mechanism, and printing means for performing printing on the tape medium.

Further objects, features, and advantages of this invention will become apparent from the following description of the preferred embodiments with reference to the attached drawings.

### BRIEF DESCRIPTION OF THE DRAWINGS

FIG. 1 is an external perspective view of a tape printer according to an embodiment of the this invention;

FIG. 2A is an external perspective view of a tape cartridge to be loaded in the tape printer, and FIG. 2B is an external perspective view of the tape printer in which a cover is opened;

FIG. 3 is an external perspective view of a cutting means and its surroundings;

FIG. 4 is an external perspective view of a cutter frame;

FIG. 5 is an external perspective view showing a full-cutting mechanism and a half-cutting mechanism and their surroundings;

FIG. 6 is an external perspective view of a full cutter;

FIG. 7 is an external perspective view of the half-cutting mechanism in which a cutting blade is at the home position;

FIG. 8 is an external perspective view of the half-cutting mechanism in which the cutting blade is operated;

FIG. 9 is a side view of a half cutter;

FIG. 10 is an explanatory view of a tape-discharging means; and

FIG. 11 is a block diagram of a control system in the tape printer.

### DETAILED DESCRIPTION OF THE PREFERRED EMBODIMENTS

A tape printer according to an embodiment of the this invention will be described in detail below with reference to the attached drawings. A tape printer of this embodiment performs printing on a tape medium contained in a tape cartridge, and then cuts the tape medium into tape pieces.

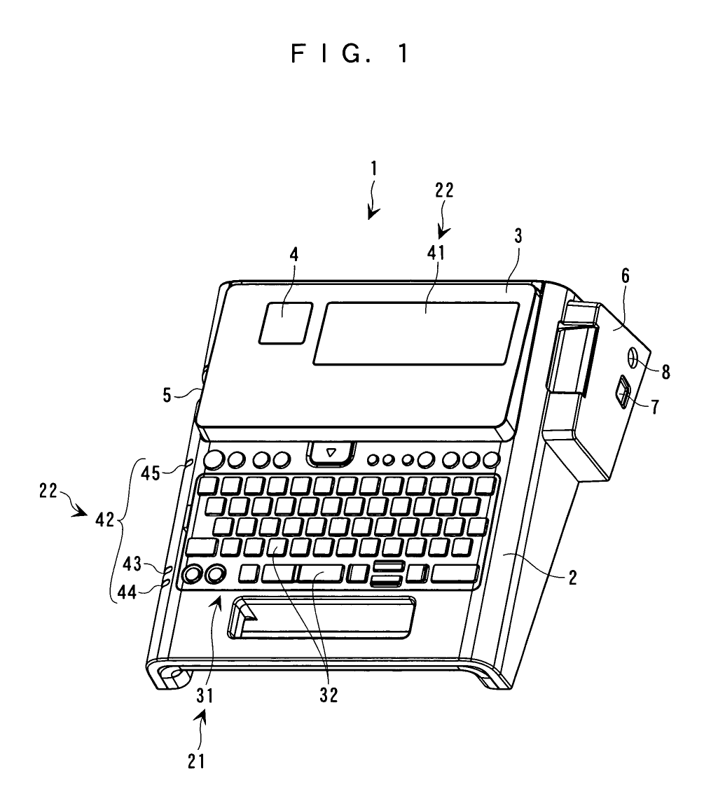

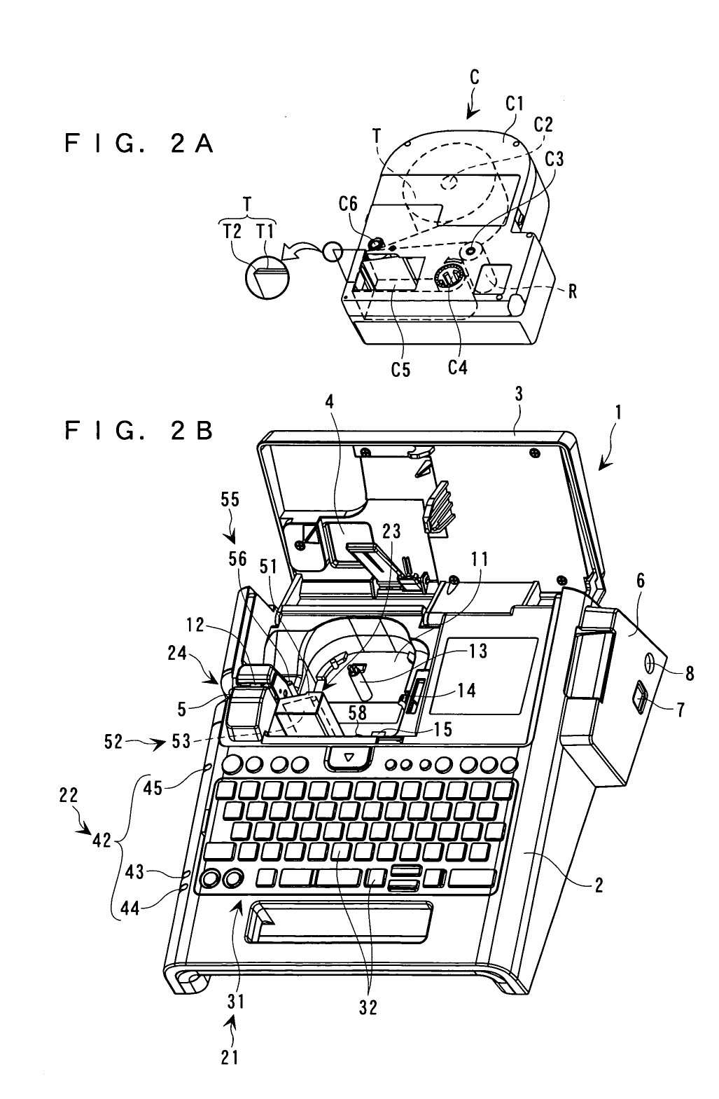

FIG. 1 is an external perspective view of the entire tape printer of the embodiment, and FIG. 2B is an external perspective view of the tape printer in which a cover is opened. As shown in FIGS. 1 and 2B, a tape printer 1 has an outer shell defined by a printer case 2. A keyboard 31 is provided at the upper front of the printer case 2, and a cover 3 having a display 41 is provided in the upper rear of the printer case 2. The cover 3 has, on the left side of the display 41, a window 4 through which a tape cartridge C loaded in a cartridge compartment 11, which will be described later, is visible.

A tape exit 5 through which a printed tape medium T is discharged is provided in the left side face of the printer case 2. A trimmer 6 for trimming an end of a tape piece in a round shape is provided in the right side face of the printer case 2. The trimmer 6 includes an external-apparatus connecting port 7 for connecting the tape printer 1 to an external apparatus, such as a personal computer, through a USB, and a power socket 8 in which a power-supply adaptor for supplying power to the tape printer 1 is plugged. The tape printer 1 can be placed (stand) in an upright position with the rear side of the printer case 2 facing down. Therefore, for example, when the tape printer 1 is used as an output apparatus for an external apparatus, it can be placed on a desk in a compact manner with the left side face of the printer case 2 having the tape exit 5 facing toward the front side.

As shown in FIG. 2B, inside the cover 3, a cartridge compartment 11 in which a tape cartridge C is detachably loaded is provided, and a tape-feeding path 12 for conveying a tape medium T to the tape exit 5 is also provided between the cartridge compartment 11 and the tape exit 5. The cartridge compartment 11 includes a cartridge-positioning shaft 13 and a pair of clamping pieces 14 that allow the tape-cartridge C to be loaded in a right position, and a platen-driving shaft 56 and a ribbon take-up shaft 58 that rotatably stand, which will be described later. The platen-driving shaft 56 faces the tape-feeding path 12. The cartridge compartment 11 also includes a head unit 52 (which will be described later) having a print head 53 that is opposite to the platen-driving shaft 56 across the tape-feeding path 12. The head unit 52 is covered with a head cover 51.

As shown in FIG. 2A, a tape cartridge C used in the tape printer 1 is entirely covered with a cartridge case C1, and includes a tape reel C2 on which a tape medium T is wound, a ribbon supply reel C3 on which an ink ribbon R is wound, and a ribbon take-up reel C4 for winding the supplied ink ribbon R. The tape cartridge C also includes a through opening C5 that is loosely fitted on the head unit 52. A platen roller C6 rotatably stands to face the through opening C5. When the tape cartridge C is loaded in the cartridge compartment 11, the platen roller C6 engages with the platen-driving shaft 56, and the ribbon take-up reel C4 engages with the ribbon take-up shaft 58, so that the tape medium T and the ink ribbon R are allowed to be conveyed.

The leading end of the tape medium T is drawn out of the tape cartridge C through a tape supply slot (not shown) provided near the through opening 5. When the tape cartridge C is loaded in the cartridge compartment 11, the drawn leading end of the tape medium T is placed in the tape-feeding path 12, and faces a full cutter 81 of a cutting means 24 which will be described later. The tape medium T is guided from the tape cartridge C to the tape exit 5 along the tape-feeding path 12. On the other hand, the ink ribbon R is superposed on the tape medium T at the through opening C5, travels around the through opening C5, and is then wound on the ribbon take-up reel C4.

A tape medium T is a laminate tape composed of a printing tape T1 having an adhesive surface, and a release paper layer T2. The tape medium T can be stuck as a label after printing. A plurality of types of tape cartridges are prepared corresponding to the types and widths of tape mediums (printing tapes), and each of the tape cartridges has a plurality of identification holes on the rear surface corresponding to the type and width of the tape medium. A tape-identifying sensor 15 is provided on a bottom plate of the cartridge compartment 11 to identify the type of a loaded tape cartridge on the basis of the layout (bit pattern) of identification holes on the rear surface of the tape cartridge.

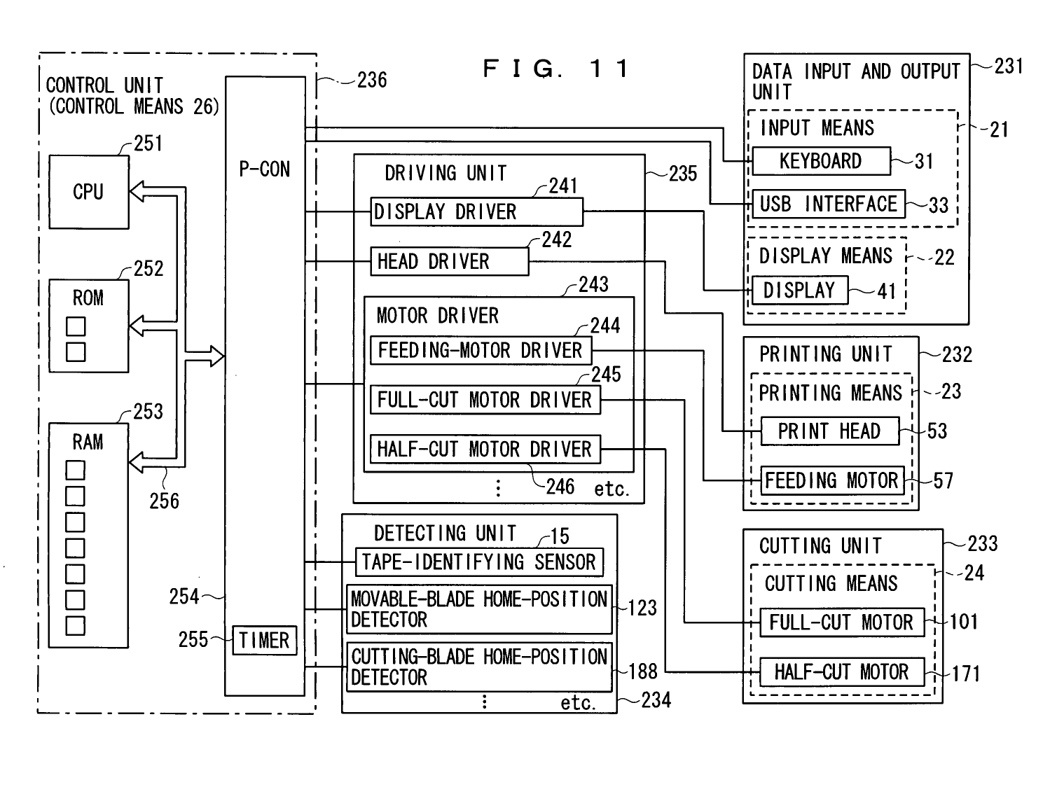

The basic configuration of the tape printer 1 will now be described. As shown in FIGS. 2B and 11, the tape printer 1 includes an input means 21 for inputting print information (setting information and image data), a display means 22 for displaying the set condition of the tape printer 1 and print information, a printing means 23 for performing printing on a tape medium T according to print information, a cutting means 24 for cutting a printed tape medium T, a tape-discharging means 25 for forcibly conveying a cut tape medium T (tape piece) to the tape exit 5, and a control means 26 for generally controlling the above means.

The input unit 21 includes the above-described keyboard 31 having various input keys 32, and a USB interface 33 for connection to an external apparatus such as a personal computer. Print information can be directly input to the tape printer 1 through the keyboard 31, and data can be exchanged with the external apparatus through the USB interface 33.

The display means 22 includes the above-described display 41 and various display lamps 42. The display lamps 42 include a power lamp 43 indicating a power-on or power-off state, a connection lamp 44 indicating whether a connection to the external apparatus is established, and a half-cut lamp 45 indicating whether a half-cutting operation is performed. These display lamps 42 are arranged on a round chamfered portion of the printer case 2 provided from the upper surface to the left side face so as to be easily viewed even when the tape printer 1 is placed in an upright position, as shown in FIGS. 1 and 2B.

As shown in FIGS. 2A and 2B, the printing means 23 performs printing according to print information while supplying a tape medium T from the tape cartridge C. The printing means 23 includes the above-described head unit 52 covered with the head cover 51, and a tape-feeding mechanism 55 for supplying and conveying a tape medium T. The head unit 52 includes a print head 53 formed of a thermal head, and a head holder (not shown) for rotatably supporting the print head 53. Although not shown, a head-release mechanism is built in the head holder. In response to opening and closing of the above-described cover 3, the head-release mechanism moves the print head 53 away from and into contact with the opposing platen roller C6 with the tape medium T and the ink ribbon R disposed therebetween. More specifically, when the cover 3 is closed, the print head 53 is pressed against the platen roller C6 with the tape medium T and the ink ribbon R disposed therebetween.

The tape-feeding mechanism 55 includes the platen roller C6 disposed in the tape cartridge C, the platen-driving shaft 56 that engages with the platen roller C6, a feeding motor 57 for rotating the platen-driving shaft 56, and a feeding-power transmission mechanism (not shown) for transmitting the power of the feeding motor 57 to the platen-driving shaft 56 while making speed reduction. When the feeding motor 57 is driven, the platen roller C6 is rotated through the platen-driving shaft 56, and the tape medium T is sequentially conveyed along the above-described tape-feeding path 12. The power of the feeding motor 57 is also transmitted to the ribbon take-up shaft 58 through the feeding-power transmission mechanism, and the platen-driving shaft 56 and the ribbon take-up shaft 58 rotate in synchronization with each other. That is, feeding of the tape medium T and take-up of the ink ribbon R are synchronized.

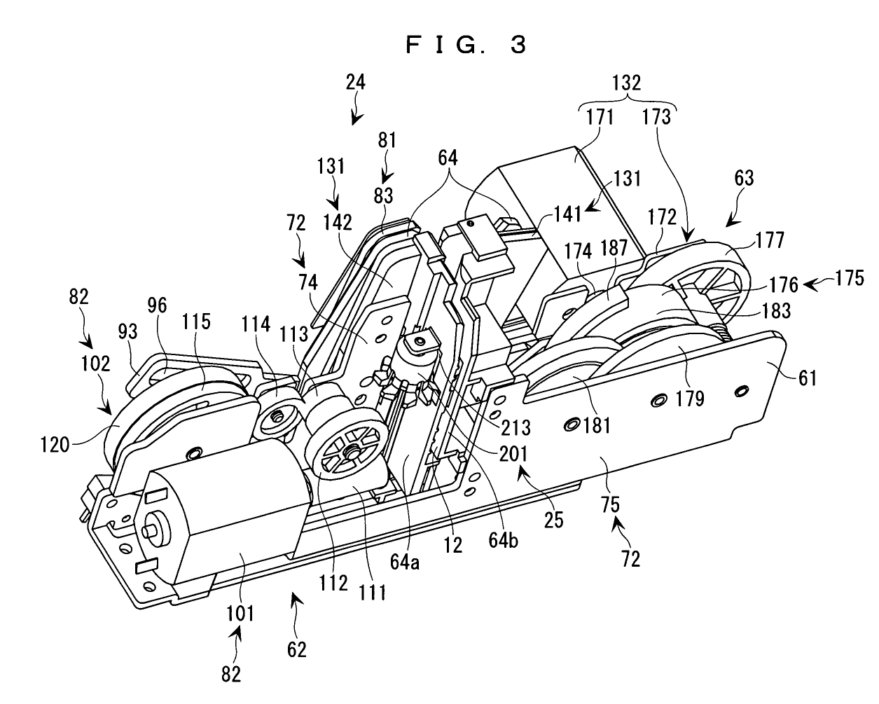

As shown in FIG. 2B, the cutting means (cutter unit) 24 is provided on the downstream side of the printing means 23 in the tape-feeding direction and near the cartridge compartment 11. As shown in FIG. 3, the cutting means 24 includes a cutter frame 61, a full-cutting mechanism 62 for cutting both a printing tape T1 and a release paper layer T2 of a tape medium T, and a half-cutting mechanism 63 for cutting only one of the printing tape T1 and the release paper layer T2 (the printing tape T1 in this embodiment). The half-cutting mechanism 63 and the full-cutting mechanism 62 are disposed on both sides of the cutter frame 61 to face the tape-feeding path 12. The cutter frame 61 includes a resin guide member 64 that defines the tape-feeding path 12 in the cutting means 24 and that guides the feeding of the tape medium T.

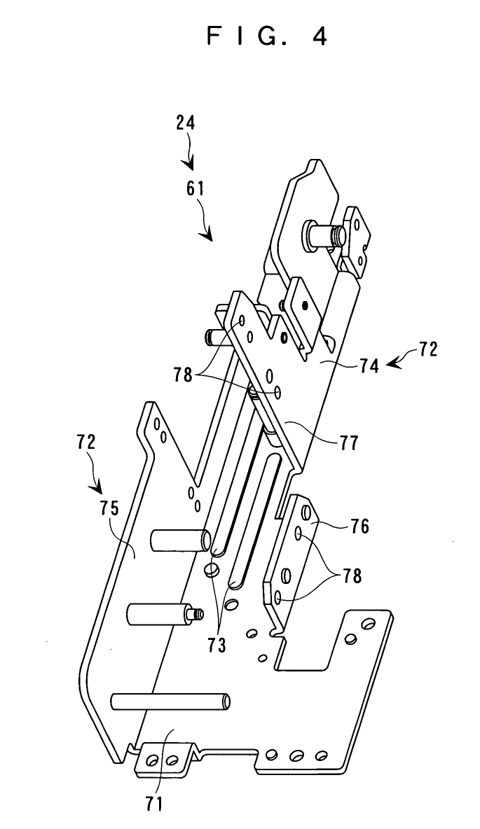

As shown in FIG. 4, the cutter frame 61 has a deformed-L shape, as viewed from the top, and is provided in a space between the left side of the cartridge compartment 11 and the printer case 2. The cutter frame 61 includes a base portion 71, and support portions 72 substantially vertically standing from the sides of the base portion 71 to support the half-cutting mechanism 63 and the full-cutting mechanism 62. The base portion 71 is disposed so that the longitudinal direction thereof is orthogonal to the above-described tape-feeding path 12 and so that the tape-feeding path 12 passes through almost the longitudinal center of the base portion 71. Two bosses 73 extend in the longitudinal direction on the surface of the base portion 71 to cross the longitudinal center. The support portions 72 include a full-cutter support portion 74 provided on the right side of the base portion 71 to mainly support the full-cutting mechanism 62, and a half-cutter support portion 75 provided on the left side of the base portion 71 to mainly support the half-cutting mechanism 63. The full-cutter support portion 74 and the half-cutter support portion 75 are diagonally opposite to each other. The half-cutting mechanism 63 is disposed on the front side of the cutter frame 61, and the full-cutting mechanism 62 is disposed on the rear side of the cutter frame 61, as shown in FIG. 3.

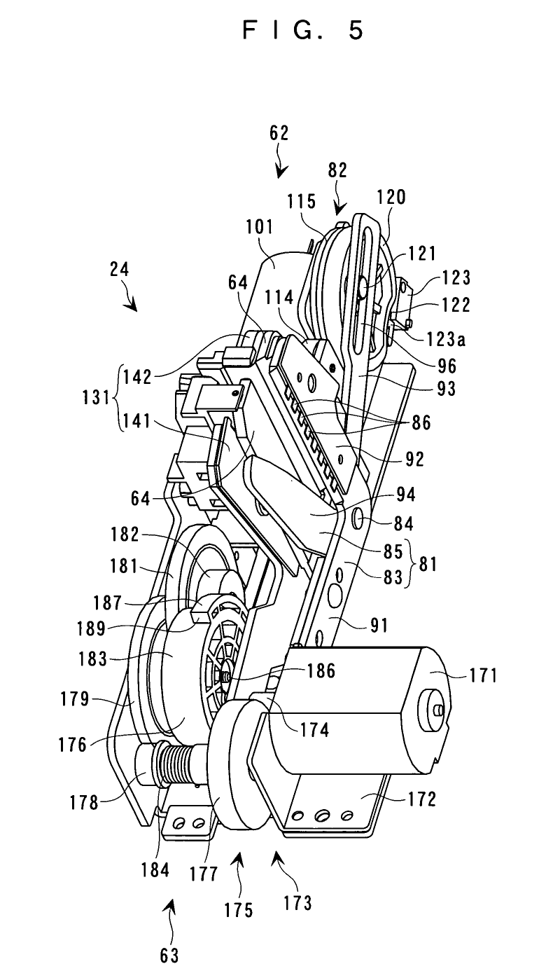

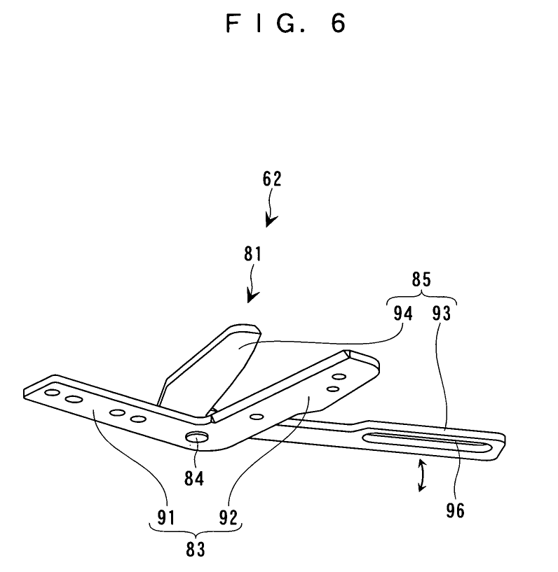

The full-cutting mechanism 62 has a full cutter shaped like a pair of scissors and composed of a fixed blade 83 and a movable blade, 85, as will be described in detail later. The fixed blade 83 has a substantially L-shaped profile defined by a fixed-blade base portion 91 and a fixed edge portion 92 (FIG. 6). The full-cutter support portion 74 has a base-portion support portion 76 and a fixed-edge support portion 77 for respectively supporting the fixed-blade base portion 91 and the fixed edge portion 92, as shown in FIGS. 4 and 5. The base-portion support portion 76 and the fixed-edge support portion 77 each have two screw holes 78 to fix the fixed-blade base portion 91 and the fixed edge portion 92.

As shown in FIGS. 3 and 5, the full-cutting mechanism 62 includes a full cutter 81 for cutting a tape medium T placed in the tape-feeding path 12 like scissors, and a full-cutter driving means 82 for supplying power to make the full cutter 81 to perform a full-cutting operation.

The full cutter 81 includes the fixed blade 83 fixed to the full-cutter support portion 74, and the movable blade 85 turnably supported by the fixed blade 83 through a pivot (caulking pin) 84. The movable blade 85 is turned (pivoted) on the pivot 84 to fully cut the tape medium T. The pivot 84 of the full cutter 81 is disposed at almost the longitudinal center of the base portion 71. The edges of the fixed blade 83 and the movable blade 85 are disposed opposite to each other with the tape-feeding path 12 therebetween.

An antistatic brush 86 for removing static electricity from the tape medium T is provided on the front side of the fixed blade 83 to extend along the edge. An oil container (not shown) for storing silicone oil serving as an antitack agent for the printing tape T1 (adhesive surface) is provided on the rear side of the fixed blade 83, and the silicone oil is automatically applied to the fixed blade 83 and the movable blade 85.

The fixed blade 83 is substantially L-shaped by the fixed-blade base portion 91 extending from the half-cutting mechanism 63 to the tape-feeding path 12 in the longitudinal direction of the base portion 71, and the fixed edge portion 92 extending upward substantially perpendicularly to the fixed-blade base portion 91. As described above, the full-cutter support portion 74 includes the base-portion support portion 76 for supporting the fixed-blade base portion 91, and the fixed-edge support portion 77 for supporting the fixed edge portion 92. The fixed-blade base portion 91 and the fixed edge portion 92 are screwed to the base-portion support portion 76 and the fixed-edge support portion 77 at two positions separate in the extending direction, as shown in FIGS. 4 and 5. The blade-receiving member 142 of the half-cutting mechanism 63 is directly fixed to the fixed-blade support portion 77, and the fixed edge portion 92 is screwed to the fixed-blade support portion 77 with the blade-receiving member 142 therebetween, as will be described in detail later.

The movable blade 85 is substantially L-shaped, in a manner similar to that in the fixed blade 83, and includes a movable-blade base portion 93 extending from the full-cutting mechanism 62 toward the tape-feeding path 12 in the longitudinal direction of the base portion 71, and a movable edge portion 94 substantially vertically extending from the movable-blade base portion 93. The movable-blade base portion 93 has a slot 96 extending in the longitudinal direction thereof, and a crank projection 121 (which will be described later) of the full-cutter driving means 82 is engaged with the slot 96.

As shown in FIGS. 3 and 5, the full-cutter driving means 82 includes a full-cut motor 101 for supplying power for a full-cutting operation, and a full-cut power transmission mechanism 102 for transmitting the power of the full-cut motor 101 to the movable blade 85. The full-cut motor 101 is formed of a servomotor, and is disposed on the base portion 71 so that its output shaft (not shown) is orthogonal to the tape-feeding path 12.

The full-cut power transmission mechanism 102 includes a worm 111 fixed to the output shaft of the full-cut motor 101, a full-cut worm wheel 112 meshed with the worm 111, a first full-cut intermediate gear 113 fixed coaxially with the full-cut worm wheel 112, a second full-cut intermediate gear 114 meshed with the first full-cut intermediate gear 113, and a full-cut transmission gear 115 meshed with the second full-cut intermediate gear 114. The full-cut worm wheel 112, the first full-cut intermediate gear 113, the second full-cut intermediate gear 114, and the full-cut transmission gear 115 are rotatably supported in a cantilevered manner on the full-cutter support portion 74. A full-cut crank wheel 120 is coaxially fixed to the full-cut transmission gear 115, and has the crank projection 121 engaged with the above-described slot 96 of the movable blade 85. The rotation of the full-cut transmission gear 115 is converted into reciprocal rotation by the crank wheel 120 through the crank projection 121, and is transmitted to the movable blade 85. That is, the full-cut power transmission mechanism 102 and the movable-blade base portion 93 constitute a swing crank mechanism. The power from the full-cut motor 101 is converted into power for a swing motion of the movable-blade base portion 93 through the full-cut power transmission mechanism 102.

As shown in FIG. 5, a detection recess 122 is provided on a part of the outer peripheral surface of the crank wheel 120 to detect the home position (cutting start position) of the movable blade 85. The full-cutter support portion 74 has a movable-blade home-position detector 123 that is in sliding contact with the outer peripheral surface of the crank wheel 120. The movable-blade home-position detector 123 is, e.g., a microswitch, and is turned on and off when the detection recess 122 faces a switch end 123a of the movable-blade home-position detector 123. The detection recess 122 faces the movable-blade home-position detector 123 when the movable blade 85 is at the home position. That is, the home position of the movable blade 85 can be detected by sensing the detection recess 122 with the movable-blade home-position detector 123.

As shown in FIGS. 3 and 5, the half-cutting mechanism 63 is provided by the side of the full cutter 81, and includes a half-cutter 131 for half-cutting a tape medium T in a force-cutting manner, and a half-cutter driver 132 for making the half cutter 131 to perform a cutting operation.

The half cutter 131 is disposed near the full cutter 81 on the downstream side in the tape-feeding direction, and includes a cutting blade 141 for biting a tape medium T, and a blade-receiving member 142 for receiving the biting cutting blade 141. The cutting blade 141 is supported on the blade-receiving member 142 to turn on a pivot 143 (caulking pin 144) provided in a base portion 161 of the blade-receiving member 142. By turning the cutting blade 141, the half cutter 131 performs cutting like scissors. The cutting direction of the cutting blade 141 is the same as the cutting direction of the movable blade 85 of the full-cutting mechanism 62. That is, the cutting blade 141 bites from the front side (print surface) of a printing tape T1.

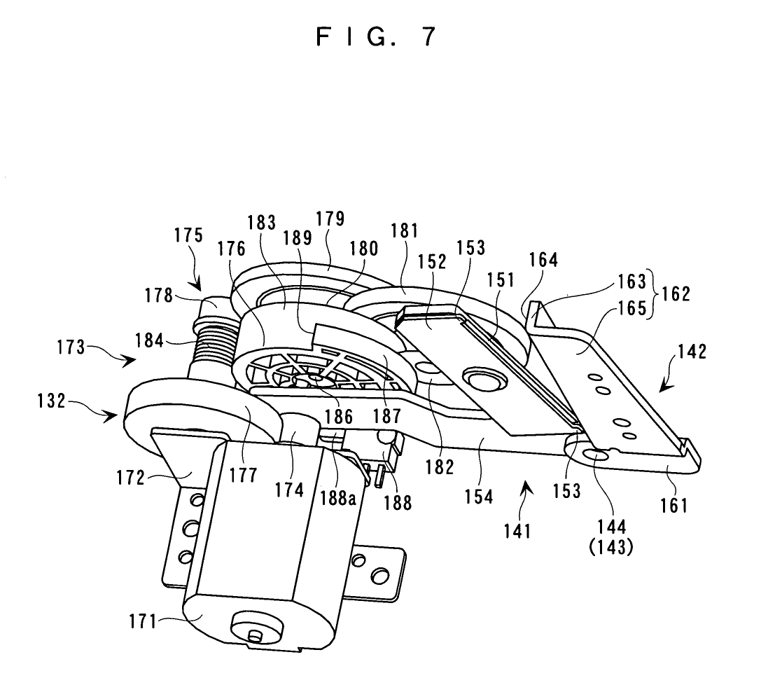

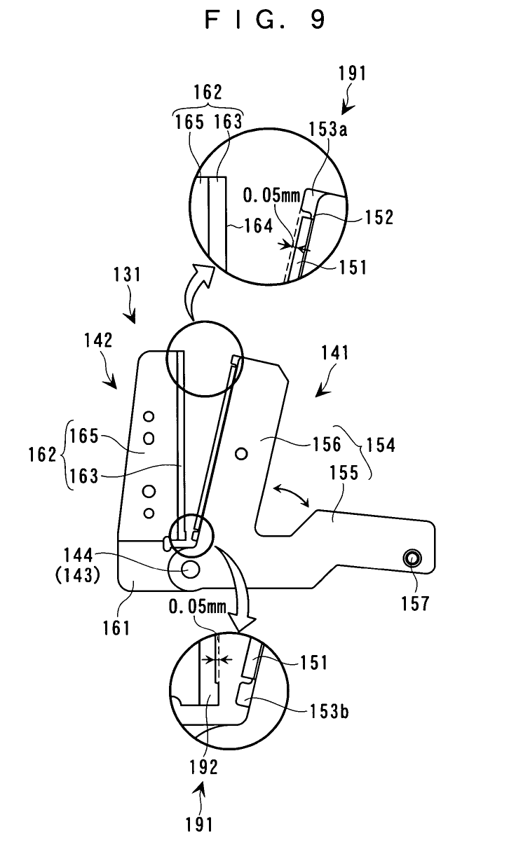

As shown in FIGS. 7 and 9, the cutting blade 141 includes a straight-tooth blade 151, a blade holder 152 for holding the blade 151, and a blade support member (arm member) 154 for turnably supporting the blade holder 152. The blade holder 152 is shaped like a substantially rectangular flat plate having two protruding portions 153 at both ends in the longitudinal direction. The blade 151 is fixed to the blade holder 152, e.g., by spot welding with the cutting edge disposed between the two protruding portions 153.

The blade support member 154 is substantially L-shaped, in a manner similar to that in the above-described movable blade 85 of the full-cutting mechanism 62. More specifically, the blade support member 154 includes an arm portion 155 that is turnably fixed to the pivot 143 of the blade-receiving member 142 at one end and that extends in the longitudinal direction of the base portion 71 from the pivot 143 toward the half-cutting mechanism 63, and a holder support portion 156 that extends upward substantially perpendicularly from near the pivot 143 of the arm portion 155 and that supports the blade holder 152. When the arm portion 155 is turned (pivoted), the blade 151 is moved toward the blade-receiving member 142 through the holder support portion 156.

A crank pin 157 for pivoting the arm portion 155 protrudes from a portion of the arm portion 155 remote from the pivot 143 toward the inside of the cutter frame 61. The blade holder 152 holding the blade 151 is supported by the holder support portion 156 to turn on the caulking pin 144 while receiving a small frictional force. In this case, the two protruding portions 153 of the blade holder 152 and the cutting edge of the blade 151 protrude toward the blade-receiving member 142. The blade holder 152 is turnably supported at the center, and the blade 151 turns on the longitudinal center. Therefore, when the cutting blade 141 is operated, the blade holder 152 (the cutting edge of the blade 151) slightly turns to follow an edge-receiving surface 164 (which will be described later) of the blade-receiving member 142, thereby canceling an error in mounting the blade holder 152 to the holder support portion 156.

The blade-receiving member 142 includes a base portion 161 having the pivot 143, and a receiving body 162 extending upward in a cranked manner from the base portion 161. The receiving body 162 is bent outward in an L-shaped cross section in plan view, and includes an edge-receiving portion 163 having an edge-receiving surface 164 for receiving the edge of the operated butting blade 141, and a fixed portion 165 fixed to the fixed-blade support portion 77 of the full-cutter support portion 74. The edge-receiving surface 164 defines a part of the tape-feeding path 12, faces the cutting blade 141, and guides a tape medium T in connection with the guide member 64. In order to properly guide the tape medium T, a guide member 64 is also disposed between the full cutter 81 and the half cutter 131, and covers a surface of the fixed portion 165 that is not in contact with the fixed-blade support portion 77, as shown in FIGS. 3 and 5.

The fixed portion 165 is directly screwed to the fixed-blade support portion 77 at two upper and lower separate positions. The fixed edge portion 92 of the above-described fixed blade 83 is screwed to the fixed portion 165 with the guide member 64 therebetween. That is, the blade-receiving member 142 is supported by both the fixed-blade support portion 77 and the fixed blade 83. For this reason, during a half-cutting operation, a pressing force (bending moment) that the edge-receiving portion 163 receives from the cutting blade 141 can be distributed to the fixed-blade support portion 77 and the fixed blade 83. This can compensate the strengths of the fixed-blade support portion 77 and the fixed blade 83.

As shown in FIGS. 3, 7 and 8, the half-cutter driving means 132 includes a half-cut motor 171 for supplying power for half-cutting, and a half-cut power transmission mechanism 173 for transmitting power of the half-cut motor 171 to the cutting blade 141. The half-cut motor 171 is formed of a servomotor that can rotate in the forward and reverse directions, and is fixed to the base portion 71 of the cutter frame 61 with a motor-fixing plate 172 disposed therebetween so that an output shaft (not shown) thereof is parallel to the tape-feeding path 12. When the half-cut motor 171 rotates forward, the cutting blade 141 of the half cutter 131 starts cutting from the home position to half-cut a tape medium T. When the half-cut motor 171 is reversed, the cutting blade 141 returns to the home position. Since the half cutter 131 cuts in a force-cutting manner, it needs a cutting torque higher than that in the scissors-type of full cutter 81. Therefore, the rated output of the half-cut motor 171 is higher than that of the full-cut motor 101.

As shown in FIG. 7, the half-cut power transmission mechanism 173 includes a driving gear 174 fixed to the output shaft of the half-cut motor 171, a train of reduction gears 175 meshed with the driving gear 174 to transmit the power of the half-cut motor 171 while making speed reduction, and a half-cut crank wheel 176 meshed with the train of reduction gears 175 to transmit the power of the half-cut motor 171 to the cutting blade 141. The train of reduction gears 175 are rotatably supported by the half-cutter support portion 75 of the above-described cutter frame 61. The train of reduction gears 175 include a first half-cut gear 177 meshed with the driving gear 174, a second half-cut gear 178 coaxially fixed to an end face of the first half-cut gear 177, a third half-cut wheel 179 meshed with the second half-cut gear 178, a third half-cut pinion 180 coaxially fixed to an end face of the third half-cut wheel 179, a fourth half-cut wheel 181 meshed with the third half-cut pinion 180, a fourth half-cut pinion 182 coaxially fixed to an end face of the fourth half-cut wheel 181, and a half-cut transmission gear 183 provided coaxially with the third half-cut wheel 179 (third half-cut pinion 180) and meshed with the fourth half-cut pinion 182. A torque limiter (a slip spring formed of a coil spring) 184 is interposed between the first half-cut gear 177 and the second half-cut gear 178 to prevent the half-cut motor 171 from being overloaded during a half-cutting operation.

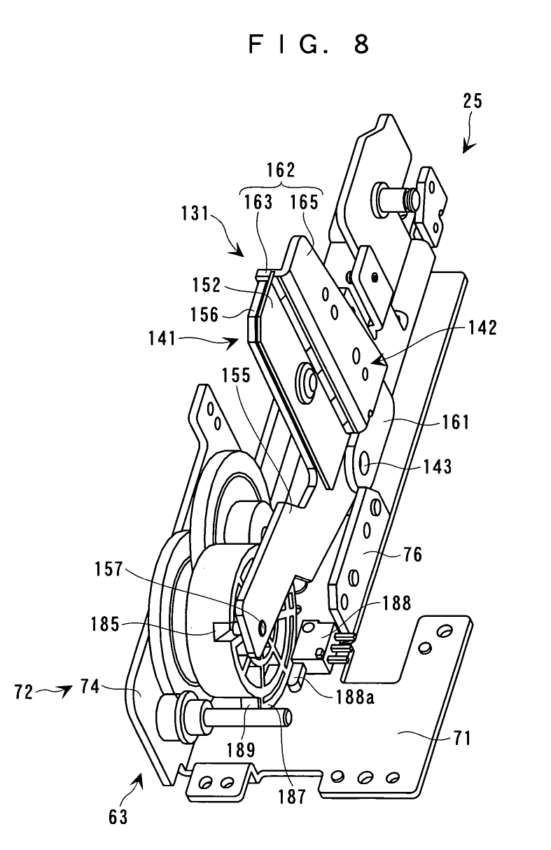

The half-cut crank wheel 176 is provided integrally with the half-cut transmission gear 183. The half-cut crank wheel 176 has a guide groove 185 that engages with the crank pin 157 of the above-described arm portion 155, and a rotational motion of the train of reduction gears 175 is converted into a swing motion of the arm portion 155. The guide groove 185 is shaped like a circular hole (centered on the pivot 143 of the half cutter 131) that is provided from the peripheral portion of the half-cut transmission gear 183 toward a rotation shaft 186 of the half-cut transmission gear 183 corresponding to the locus of the crank pin 157. When the half-cut motor 171 rotates forward and the cutting blade 141 continues cutting, the crank pin 157 moves closer to the rotation shaft 186. When cutting by the cutting blade 141 is completed and the half-cut motor 171 is reversed, the crank pin 157 moves away from the rotation shaft 186, as shown in FIGS. 7 and 8. That is, as cutting by the cutting blade 141 progresses, the cutting torque of the cutting blade 141 can increase. Therefore, the tape medium T can be half-cut smoothly.

As shown in FIG. 7, a detecting projection 187 having a fan-shaped profile is provided on a part of the outer peripheral surface of the half-cut crank wheel 176. The above-described half-cutter support portion 75 has a cutting-blade home-position detector 188 that is in sliding contact with the outer peripheral surface of the detecting projection 187. The cutting-blade home-position detector 188 detects the home position of the cutting blade 141 by sensing the detecting projection 187.

More specifically, the detecting projection 187 is provided corresponding to the rotation range of the half-cut crank wheel 176 so as to be brought into sliding contact with the cutting-blade home-position detector 188 when the half-cut motor 171 rotates forward. When the cutting blade 141 is at the home position, the detecting projection 187 is separate from the cutting-blade home-position detector 188, and the cutting-blade home-position detector 188 is in an off state. When the half-cut motor 171 rotates forward, the detecting projection 187 depresses a switch end 188a of the cutting-blade home-position detector 188 and makes sliding contact therewith from a stepped portion 189, and the cutting-blade home-position detector 188 is turned on. In contrast, when cutting buy the cutting blade 141 is completed and the half-cut motor 171 reversed, the cutting blade 141 returns to the home position. In this case, the detecting projection 187 separates from the cutting-blade home-position detector 188 from the stepped portion 189. That is, it is detected that the cutting blade 141 is returned to the home position when the cutting-blade home-position detector 188 is switched from an on state to an off state.

As described above, the half cutter 131 of this embodiment half-cuts a tape medium T in a force-cutting manner. In order to reliably half-cut a tape medium T except a printing tape T1 (or a release paper layer T2), the half cutter 131 has a pair of regulating members 191 for regulating the space between the edge of the blade 151 and the edge-receiving surface 164.

The regulating members 191 will be more specifically described with reference to FIG. 9. The regulating members 191 are provided at the cutting blade 141 and the blade-receiving member 142, respectively. A regulating member 191 at the cutting blade 141 is formed by one of the above-described two protruding portions 153 of the blade holder 152, namely, a protruding portion 153a (blade-side regulating member). The protruding portion 153a serving as the regulating member 191 protrudes from the other protruding portion 153b toward the edge-receiving surface 164 by an amount corresponding to the thickness (0.05 mm) of the release paper layer T2 (or the printing tape T1) of the tape medium T. In contrast, a regulating member 191 at the blade-receiving member 142 is formed by a regulating projection 192 (receiving-side regulating member) provided at the edge-receiving surface 164. The regulating projection 192 is provided corresponding to the position of the other protruding portion 153b of the blade holder 152 that does not form the regulating member 191, and protrudes toward the cutting blade 141 by the amount corresponding to the thickness (0.05 mm) of the release paper layer T2 (or the printing tape T1) of the tape medium T.

The regulating projection 192 of the edge-receiving surface 164 is formed with a receiving-surface shaping jig (not shown). The receiving-surface shaping jig has a pressing surface (not shown) to be pressed against the edge-receiving surface 164. A groove having a depth of 0.05 mm is provided at a predetermined position of the pressing surface. When the pressing surface of the receiving-surface shaping jig is pressed against the edge-receiving surface 164, the edge-receiving surface 164 is made flat and smooth, and the regulating projection 192 is formed at a predetermined position of the edge-receiving surface 164.

The blade 151 is fixed to the blade holder 152 so that its edge line is flush with the leading end of the lower protruding portion 153b of the blade holder 152, that is, is parallel to the leading end face of the protruding portion 153a at the front end in the cutting direction, as shown in FIG. 9. Therefore, when the cutting blade 141 is turned, the leading end face of the protruding portion 153a of the blade holder 152 abuts against the edge-receiving surface 164, the leading end face of the regulating projection 192 of the edge-receiving surface 164 abuts against the leading end face of the protruding portion 153b of the blade holder 152, and a gap corresponding to the thickness (0.05 mm) of the release paper layer T2 (or the printing tape T1) is formed between the edge of the blade 151 and the edge-receiving surface 164. In this case, preferably, the blade holder 152 is attached to the blade support member 154 so that the protruding portion 153a of the blade holder 152 is placed on the upper side, that is, at the leading end of the blade 151, and the regulating projection 192 is disposed at the base end of the edge-receiving surface 164 near the pivot 143.

The blade holder 152 has, on its upper surface, a positioning recess (not shown) in which the blade 151 is fitted in a right position. Since the edge line of the blade 151 is flush with the leading end of the protruding portion 153b, the blade 151 can be precisely fixed to the blade holder 152 by utilizing both the protruding portion 153b and the positioning recess.

Regarding the “half cutting,” it is to be understood that the object of half cutting is to allow the printing tape to be peeled off (or removed away from) the release paper, or vice versa, by forming a cutting line. Therefore, even if a slight cutting line is formed (“inadvertently” in a sense) into the release paper or printing tape whichever the case may be, it will not give rise to a particular problem in performing half cutting. In that sense, it may be so arranged that the above-described “gap” is kept to a value enabling to execute half cutting.

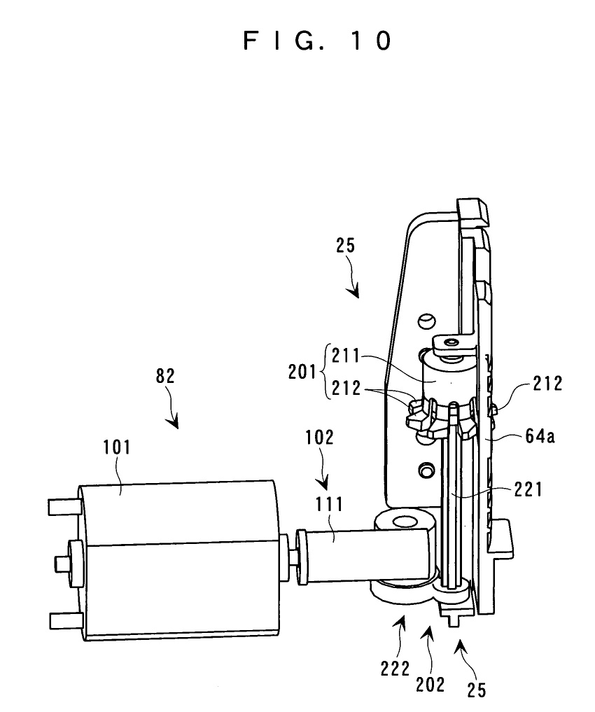

As shown in FIG. 10, the tape-discharging means 25 is provided inside the cutting means 24 so as to face the tape-feeding path 12, and includes a discharging roller 201 for forcibly discharging a tape medium T cut by the full-cutting mechanism 62, and a discharging-roller driving mechanism 202 for making the discharging roller 201 to perform a discharging operation. The guide member 64 that defines the tape-feeding path 12 includes a full-cut guide portion 64a on the side of the full-cutting mechanism 62, and a half-cut guide portion 64b on the side of the half-cutting mechanism 63. The discharging roller 201 is provided at the back of the full-cut guide portion 64a.

The discharging roller 201 is made of an elastic material such as rubber, and includes a rotation base 211, and a plurality of discharging projections 212 provided at the lower peripheral edge of the rotation base 211. The discharging projections 212 protrude in the normal direction of the rotation base 211, and are equally spaced in the circumferential direction of the rotation base 211. The full-cut guide portion 64a has an opening 213, as shown in FIG. 3, and the discharging roller 201 is disposed so that the discharging projections 212 protrude in the tape-feeding path 12 through the opening 213. That is, when the discharging roller 201 rotates, the discharging projections 212 sequentially touch a tape medium T (release paper layer T2) in the tape-feeding path 12, thereby discharging the tape medium T in the tape-feeding direction.

The discharging-roller driving mechanism 202 includes a discharging-roller rotation shaft 221 for rotating the discharging roller 201, and a train of discharging gears (bevel gear) 222 meshed with the worm 111 of the above-described full-cut power transmission mechanism 102 to rotate the discharging-roller rotation shaft 221. The discharging-roller driving mechanism 202 shares the full-cut motor 101 as a power source with the full-cutting mechanism 62. Therefore, the discharging roller 201 can be rotated in synchronization with a cutting operation with the full-cutting mechanism 62, and the tape medium T can be discharged only during a full-cutting operation.

The control means 26 is connected to the above-described means in the tape printer 1 to generally control the tape printer 1.

A main control system in the tape printer 1 will now be described with reference to FIG. 11. The tape printer 1 includes a data input and output unit 231 for inputting and outputting print information and various commands, a printing unit 232 for printing on a tape medium, a cutting unit 233 for cutting a printed tape medium, a detection unit 234 for various detecting operations, a driving unit 235 for driving the units, and a control unit 236 for generally controlling the tape printer 1.

The data input and output unit 231 includes the input means 21 and the display means 22. The printing unit 232 includes the printing means 23, and performs printing on a tape medium T while supplying the tape medium T from the tape cartridge C by synchronously driving the print head 53 and the feeding motor 57. The cutting unit 233 includes the cutting means 24. The cutting unit 233 half-cuts a tape medium T conveyed from the printing unit 232 by driving the half-cutting mechanism 63, and then cuts the tape medium T at a predetermined position by driving the full-cutting mechanism 62. The detection unit 234 includes various sensors such as the tape-identifying sensor 15, the movable-blade home-position detector 123, and the cutting-blade home-position detector 188 described above. The driving unit 235 includes various drivers such as a display driver 241 for driving the display 41, a head driver 242 for driving the print head 53, and a motor driver 243 for driving the motor. The motor driver 243 includes, e.g, a feeding-motor driver 244 for driving the feeding motor 57, a full-cut-motor driver 245 for driving the full-cut motor 101, and a half-cut-motor driver 246 for driving the half-cut motor 171.

The control unit 236 includes a CPU 251, a ROM 252, a RAM 253, and a peripheral control circuit (P-CON) 254 that are connected by an internal bus 255. The ROM 252 has a control program region that stores a control program to be executed by the CPU 251, and a control data region that stores control data including a color conversion table and a character modification table. The RAM 253 is used as a work space for control, and includes an image data region that stores input image data, a print image data region that stores print image data created for printing based on image data, color conversion buffer regions corresponding to the respective colors, and various registers.

The P-CON 254 incorporates a logical circuit, including, e.g., a gate array and a custom LSI, that exchanges an interface signal with a peripheral circuit. That is, the P-CON 254 brings print data and various detection signals from a host computer and the units of the tape printer 1 into the internal bus 256 directly or after processing, and outputs data and a control signal, which are output from the CPU 251 and the like to the internal bus 256, to the units of the tape printer 1 in connection with the CPU 251. The P-CON 254 also incorporates a timer 255 for time control.

The CPU 251 inputs various detection signals, commands, and data through the P-CON 254 according to the control program stored in the ROM 252, processes various data in the RAM 253, and then outputs a control signal to the driving unit 235 through the P-CON 254. The entire tape printer 1 is controlled by thus controlling the units of the tape printer 1 by the control unit 236.

For example, the control unit 236 (control means 26) controls the driving of the half-cut motor 171 in connection with the cutting-blade home-position detector 188, so that the half-cutting mechanism 63 can properly perform a cutting operation. A control method for the half-cutting mechanism 63 during a cutting operation will be described more specifically. As described above, the cutting blade 141 of the half-cutting mechanism 63 performs cutting with the forward rotation of the half-cut motor 171, and returns to the home position with the reverse rotation of the half-cut motor 171. When half-cutting is started, the control unit 236 drives the half-cut motor 171 forward through the half-cut-motor driver 246. Correspondingly, the switch of the cutting-blade home-position detector 188 is depressed by the above-described detecting projection 187 of the half-cut crank wheel 176, and a detection signal is sent from the cutting-blade home-position detector 188 to the control unit 236. That is, the control unit 236 detects that the cutting blade 141 is normally operated, by detecting the change from the OFF state to the ON state of the cutting-blade home-position detector 188.

In conjunction with the timer 255, the control unit 236 stops the forward rotation of the half-cut motor 171 after a predetermined time t has passed since it was detected that the cutting-blade home-position detector 188 was turned on (timer control). The predetermined time t is a time required from the beginning of the cutting operation by the cutting blade 141 to reliable completion of half-cutting of a tape medium T. The predetermined time t is experimentally determined, and is stored beforehand in the above-described ROM 252.

Subsequently, the cutting blade 141 is returned to the home position by reversing the half-cut motor 171. That is, when the cutting-blade home-position detector 188 detects that the cutting blade 141 has returned to the home position, that is, when the cutting-blade home-position detector 188 is switched from the ON state to the OFF state, the control unit 236 stops the reverse rotation of the half-cut motor 171, thus completing the half-cutting operation. In this way, since it is physically detected that the cutting blade 141 is returned to the home position, the cutting blade 141 can be reliably returned to the home position.

According to the half-cutting mechanism of this invention, there are provided a pair of regulating members for regulating the gap between the edge of the blade portion and the edge-receiving surface of the blade-receiving member when the cutting blade is operated toward the tape medium. Therefore, the cutting depth into the tape medium can be accurately regulated. As a result, too small a half cutting depth or too large a half cutting depth can be prevented, thereby assuring adequate half cutting of the tape medium.

In addition, since the tape printer of this invention is provided with the above-described cutter unit or the half-cutting mechanism, the cutting depth of the cutting blade into the tape medium can be precisely regulated to thereby perform the adequate half cutting of the tape medium.

While this invention has been described with reference to what is presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A cutter unit comprising:
a cutter frame;
a scissors-type of full cutter including a fixed blade fixed to the cutter frame and a movable blade pivotally supported on the fixed blade; and
a force-cutting half cutter including a straight-tooth cutting blade and a blade-receiving member for receiving the cutting blade when the cutting blade is operated,
wherein the full cutter and the half cutter are disposed close to each other so as to face a feeding path for a tape medium to be cut, and the blade-receiving member is fixed to the fixed blade.

2. The cutter unit according to claim 1, wherein the cutter frame includes a blade-receiving-member support portion for fixing the blade-receiving member, and a fixed-blade support portion for fixing the fixed blade, the blade-receiving member is fixed to the blade-receiving-member support portion, and the fixed blade is fixed to the fixed-blade support portion and is also fixed to the blade-receiving-member support portion with the blade-receiving member disposed therebetween.

3. The cutter unit according to claim 2, wherein a resin spacer is interposed between the fixed blade and the blade-receiving member.

4. The cutter unit according to claim 2, wherein substantially L-shaped, the base portion is fixed to the fixed-blade support portion, and the edge portion is fixed to the blade-receiving-member support portion.

5. The cutter unit according to claim 1, further comprising:
full-cutter driving means for making the full cutter to perform a full-cutting operation; and
half-cutter driving means for making the half cutter to perform a half-cutting operation,
wherein the full-cutter driving means and the half-cutter driving means are disposed on both sides of the feeding path.

6. The cutter unit according to claim 5, further comprising:
tape-discharging means operated by the full-cutter driving means to forcibly discharge the tape medium after the full-cutting operation.

7. A half-cutting mechanism comprising:
a cutting blade having a straight-tooth blade portion; and
a blade-receiving member for receiving the cutting blade parallelly opposite to an edge line of the blade portion when the cutting blade is operated,
wherein one of a printing tape and a release paper layer that constitute a laminate tape medium is cut in a force-cutting manner by abutting the cutting blade against the blade-receiving member while the laminate tape medium is placed between the cutting blade and the blade-receiving member,
wherein the half-cutting mechanism further comprises a pair of regulating members for regulating a gap between an edge of the blade portion and an edge-receiving surface of the blade-receiving member, and
wherein the regulating members include a blade-side regulating member provided on the cutting blade to protrude toward the blade-receiving member, and a receiving-side regulating member provided on the blade-receiving member to protrude toward the cutting blade, and the regulating members are disposed outside the blade portion in the longitudinal direction of the blade portion.

8. The half-cutting mechanism according to claim 7, wherein the cutting blade includes a blade holder for holding the blade portion so that the edge line of the blade portion is parallel to a front end face of the blade holder in the cutting direction, and the blade-side regulating member is disposed on the front end face of the blade holder so as to abut against the edge-receiving surface.

9. The half-cutting mechanism according to claim 8, wherein the blade holder has a recess for positioning the blade portion, and the blade portion is held in the recess so that the edge of the blade portion is flush with the front end face of the blade holder in the cutting direction.

10. The half-cutting mechanism according to claim 8, wherein the cutting blade has an arm member for supporting the center of the blade holder so that the blade holder turns.

11. The half-cutting mechanism according to claim 7, wherein the cutting blade performs a half-cutting operation by turning the blade portion on a pivot provided in a base portion of the blade-receiving member.

12. The half-cutting mechanism according to claim 11, wherein the blade-side regulating member is provided at a leading end of the cutting blade, and the receiving-side regulating member is provided in the base portion.

13. The half-cutting mechanism according to claim 7, further comprising:
a half-cut motor for making the cutting blade to perform a half-cutting operation;
a power transmission mechanism for transmitting power of the half-cut motor to the cutting blade;
home-position detecting means for detecting the home position of the cutting blade; and
control means for making the cutting blade to perform the half-cutting operation by driving the half-cut motor for a predetermined period of time with a timer control when the cutting blade reaches the home position.

14. The half-cutting mechanism according to claim 13, wherein the power transmission means includes a torque limiter that limits a force-cutting pressure applied from the cutting blade to the tape medium.

15. A tape printer comprising:
the cutter unit according to claim 1; and
printing means for performing printing on the tape medium.

16. A tape printer comprising:
the half-cutting mechanism according to claim 7; and
printing means for performing printing on the tape medium.
